(19) United States
(12) Patent Application Publication
(10) Pub. No.: US 2005/0014668 A1
(43) Pub. Date: Jan. 20, 2005

(54) Containers

(76) Inventors: Mathieu Bariou, Montvale, NJ (US); David Augustus Chang, Montvale, NJ (US); Vincent Legeay, Guichen (FR)

Correspondence Address: NORRIS, MCLAUGHLIN & MARCUS, 875 THIRD AVE, 18TH FLOOR, NEW YORK, NY, 10022, US

(21) Appl. No.: 10/495,017

(22) PCT Filed: Oct. 10, 2002
(86) PCT No.: PCT/GB02/04596

(30) Foreign Application Priority Data
Nov. 13, 2001 (EP) 01402912.8
Dec. 18, 2001 (GB) 0130178.7
May 28, 2002 (GB) 0212161.4
Aug. 2, 2002 (GB) 0217956.2
Aug. 30, 2002 (GB) 0220111.9

(51) Int. Cl. C11D 1/00

(52) U.S. Cl. 510/191

(57) ABSTRACT

The present invention provides an in the toilet bowl article where the active compositions, for example, a cleaning, disinfecting, and/or lime scale removing composition is separate from a perfume. The composition and perfume are placed in a housing such that the composition is in the path of the flushing toilet water and the perfume is not in the path of the flushing toilet water.

### FIELD OF THE INVENTION

The invention relates to ITB (in the bowl) toilet article of manufacture comprising a treatment compositions, wherein the compositions, for example, cleaning, disinfecting, anti-lime scale agent, or water treatment, or mixtures thereof, a perfume, and a housing for the composition and perfume.

### BACKGROUND OF THE INVENTION

Solid, liquid and gel lavatory treatment compositions are well known in the art. Such treatment compositions are typically designed to release active materials, including fragrance (or perfume), throughout their life. For example ITB (in the bowl) lavatory treatment compositions are known which are hung from the rim of the lavatory bowl in a conventional container and which are designed to release fragrance and cleansing components of the block into the toilet bowl when the toilet is flushed.

Such lavatory treatment compositions are conventionally based on a single homogenous formulation, which typically comprises a mixture of one or more bleaching agents, surfactants, fragrances and binders. The resulting formulation is in the form of a gel, liquid, or solid.

A disadvantage with such treatment compositions is that a constant release of active materials throughout the life of the liquid, gel or solid form of treatment compositions cannot be achieved. The rate of release of an active material is linked not only to the concentration of the active material in the block but also to the size of the block. Thus a reduction in the surface area of the liquid, gel, or solid form of treatment compositions during the life thereof will result in a reduction in the level of release of the active material.

By putting in a higher concentration of perfumes which are blends of various aromatic and non aromatic compounds and are usually immiscible with water, there is a tendency that, if the quantity of other incipients of the block are not maintained properly, the fragrance starts oozing out from the block during manufacture. Furthermore in higher concentrations, the perfumes may leach out as oily droplets on the surface of the water in the bowl.

We have developed an ITB article of manufacture wherein the cleaning, disinfecting, water treatment, or anti-lime scale agent composition and mixtures thereof, in liquid, gel or solid form, is separate from a fragrance or perfume such that only the cleaning, disinfecting, water treatment, or anti-lime scale agent composition and mixtures thereof is exposed to water when a toilet is flushed and the fragrance or perfume is not, allowing for a constant fragrance to be detected in a toilet room. In so doing, the fragrance life of the article is extended and manufacturing and use issues discussed above are no longer present.

### SUMMARY OF THE INVENTION

According to the invention there is provided an in the toilet bowl article of manufacture which provides a cleaning, disinfecting, anti-lime scale agents, or water treatment composition and mixtures thereof in liquid, gel or solid form which is released into flushing water when the toilet is flushed as well as providing a fragrance to be emitted into the toilet bowl, the fragrance not being in contact with the flushing water. Such an article comprises
a) a cleaning, disinfecting, water treatment, or anti-lime scale agent composition and mixtures thereof;
b) a perfume; and
c) a housing comprising (i) a first chamber having a cover for containing said composition, the first chamber having a cover and having at least one inlet opening and at least one outlet opening; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water.

For the present invention, the at least one inlet opening is placed in the first chamber and/or the cover thereof with variations including the inlet placed in the first chamber, the inlet placed in the cover of the first chamber, and an inlet is placed both in the first chamber and in the cover of the first chamber.

Other embodiments of the present invention comprise elements a) and b) above with c) having one of the following variations:
c) a housing comprising (i) a first chamber having a cover for containing said composition, the first chamber having a cover having at least one inlet opening and at least one outlet opening, said at least one inlet opening is placed in the first chamber; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water; or
c) a housing comprising (i) a first chamber having a cover for containing said composition, the first chamber having a cover having at least one inlet opening and at least one outlet opening, said at least one inlet opening is placed in the cover of the first chamber; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water; or
c) a housing comprising (i) a first chamber having a cover for containing said composition, the first chamber having a cover having at least one inlet opening and at least one outlet opening, with at least one inlet opening placed in the first chamber and with at least one inlet opening placed in the cover of the first chamber; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water; or
c) a housing comprising (i) a first chamber having a cover for containing said composition, the first chamber having a cover having at least one inlet opening and at least one outlet opening, said at least one inlet opening is placed in the first chamber; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water.

Preferably, the perfume is a gelled perfume and the second chamber does not enclose the perfume. If a liquid perfume is used, then the second chamber is covered to enclose the perfume and the cover on the second chamber contains at least one opening to allow emanation of the perfume.

The solid cleaning composition generally comprises
i) about 0 to about 100 wt % of one or more nonionic surfactants;
ii) about 100 to about 0 wt % of one or more anionic surfactants; and
iii) about 0 to 30 wt % of one or more processing aids, colorants, dyes, and the like.

Preferably, the range of nonionic surfactants is from about 3 to about 80 wt %, more preferably from about 3 to about 55 wt %, and more preferably from about 3 to about 25 wt %. Preferably, the range of anionic surfactants is from about 90 to about 50 wt %, more preferably from about 75 to about 45 wt %; Preferably, the range of one or more processing aids is from about 20 to about 25 wt %.

### BRIEF DESCRIPTIONS OF THE INVENTION

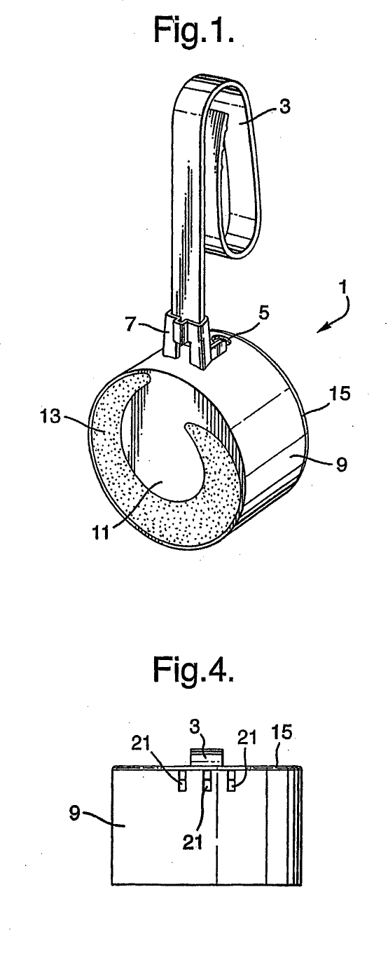

FIG. 1 shows a front perspective view of an example of the article of the present invention.

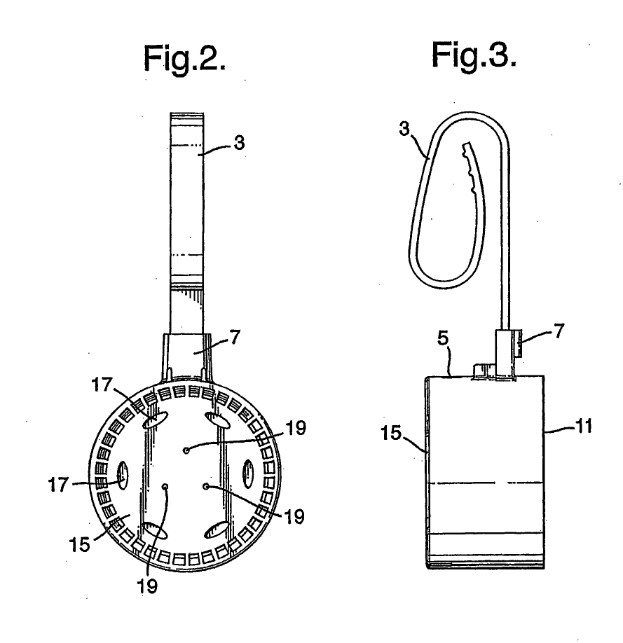

FIG. 2 shows a rear view of an example of the article of the present invention.

FIG. 3 shows a side view of an example of the article of the present invention.

FIG. 4 shows a bottom view of an example of the article of the present invention.

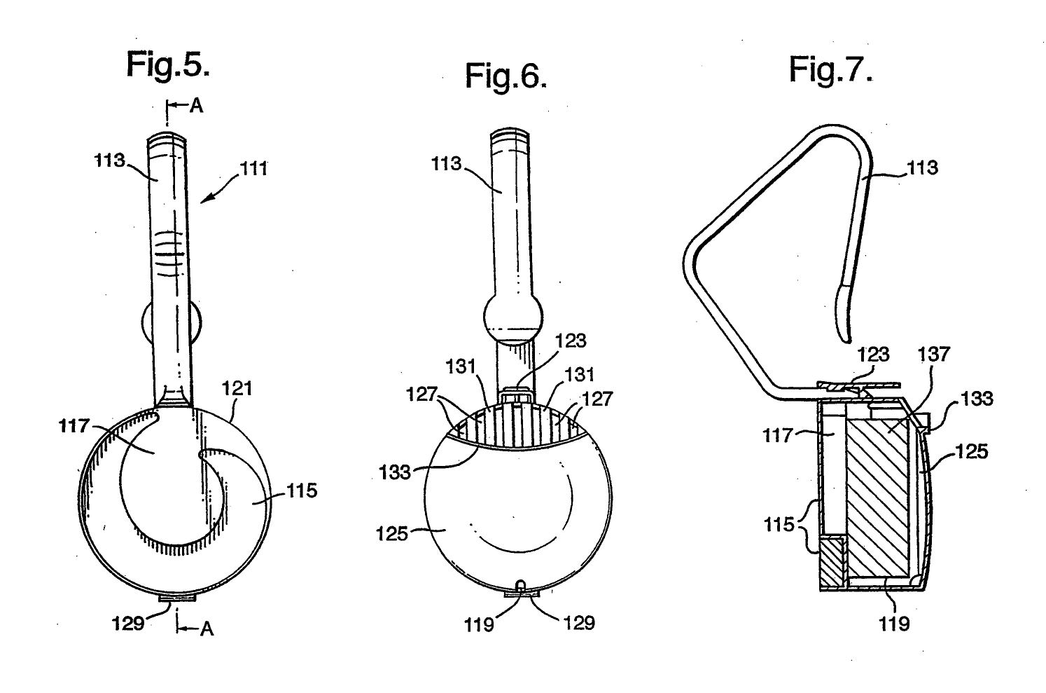

FIG. 5 shows a front view of another example of the article of the present invention.

FIG. 6 shows a rear view of the article of FIG. 5 of the present invention.

FIG. 7 shows a side view of the article of FIG. 5 of the present invention through line A-A.

### DETAILED DESCRIPTION OF THE INVENTION

According to the invention there is provided an in the toilet bowl article of manufacture which provides a cleaning, disinfecting, anti-lime scale agents, or water treatment composition and mixtures thereof in solid form which is released into flushing water when the toilet is flushed as well as providing a fragrance to be emitted into the toilet bowl, the fragrance not being in the path of the toilet flushing water. Such an article comprises
a) a cleaning, disinfecting, water treatment, or anti-lime scale agent composition and mixtures thereof;
b) a perfume; and
c) a housing comprising (i) a first chamber having a cover for containing said composition, the first chamber having a cover and having at least one inlet opening and at least one outlet opening; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water.

For the present invention, the at least one inlet opening is placed in the first chamber and/or the cover thereof with variations including the inlet placed in the first chamber, the inlet placed in the cover of the first chamber, and an inlet is placed both in the first chamber and in the cover of the first chamber.

Other embodiments of the present invention comprise elements a) and b) above with c) having one of the following variations:
c) a housing comprising (i) a first chamber having a cover for containing said composition, the first chamber having a cover having at least one inlet opening and at least one outlet opening, said at least one inlet opening is placed in the first chamber; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water; or
c) a housing comprising (i) a first chamber having a cover for containing said composition, the first chamber having a cover having at least one inlet opening and at least one outlet opening, said at least one inlet opening is placed in the cover of the first chamber; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water; or
c) a housing comprising (i) a first chamber having a cover for containing said composition, the first chamber having a cover having at least one inlet opening and at least one outlet opening, with at least one inlet opening placed in the first chamber and with at least one inlet opening placed in the cover of the first chamber; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water; or
c) a housing comprising (i) a first chamber having a cover for containing said composition, the first chamber having a cover having at least one inlet opening and at least one outlet opening, said at least one inlet opening is placed in the first chamber; (ii) a second optionally covered chamber for containing said perfume; and (iii) a hanger for removably hanging the housing from the rim of a toilet, such that when the article is suspended in the toilet bowl at least one inlet opening of the first covered chamber is in the path of flushing water and the second chamber is not in the path of flushing water.

Preferably, the perfume is a gelled perfume and the second chamber does not enclose the perfume. If a liquid perfume is used, then the second chamber is covered to enclose the perfume and the cover on the second chamber contains at least one opening to allow emanation of the perfume.

The solid cleaning composition generally comprises
i) about 0 to about 100 wt % of one or more nonionic surfactants;
ii) about 100 to about 0 wt % of one or more anionic surfactants; and
iii) about 0 to 30 wt % of one or more processing aids, colorants, dyes, and the like.

Preferably, the range of nonionic surfactants is from about 3 to about 80 wt %, more preferably from about 3 to about 55 wt %, and more preferably from about 3 to about 25 wt %. Preferably, the range of anionic surfactants is from about 90 to about 50 wt %, more preferably from about 75 to about 45 wt %; Preferably, the range of one or more processing aids is from about 20 to about 25 wt %.

The disinfecting composition can be those disinfectants compositions known to those of ordinary skill in the art, for example, including compositions containing alkyl halohydantoins, alkali metal haloisocyanurates, essential oils, non-quaternary ammonium based germicidals, and quaternary ammonium germicidals. These disinfecting blocks can consist entirely of the disinfecting material or can be an effective amount of disinfectant together with fillers, colorants, dyes, and the like.

The anti-lime scale agent composition can also be those anti-lime scale agent compositions known to those of ordinary skill in the art. For example, compositions containing anionic and/or nonionic surfactants together with typical anti-lime-scale agents, for example, amidosulfonic acid, bisulfate salts, organic acids, organic phosphoric salts, alkali metal polyphosphates, and the like. Examples of anti-lime scale agent compositions can be found in, for example, U.S. Pat. No. 5,759,974; U.S. Pat. No. 4,460,490; and U.S. Pat. No. 4,578,207 with the understanding that any perfumes in these types of compositions are removed.

It will be appreciated by those of ordinary skill in the art that several of the components that form a cleaning, disinfecting, or anti-lime scale agent can be blended into one composition with the additional appreciation that potential blending of incompatible components will be avoided.

Preferably when the composition is in a solid form, the solid composition according to the invention is made up into a block of from about 25 to about 75 g, more preferably from about 25 to about 55 g, and more preferably from about 30 to about 45 g.

The solid block can be made by conventional means from the known compounds. One method of making the block is to melt the components making up the compositions of interest and then pouring the molten mass into the first chamber of the housing and allowing the mass to cool to room temperature (about 25° C.). Another method is to place the components of interest into an appropriate extrusion device and extrude an appropriately sized mass that will fit into the first chamber of the housing. If the solid is to be made by extrusion, then processing aids are needed.

The nonionic surfactants used in a) i) are selected from primary and secondary alcohol ethoxylates and alkoxy block copolymers based on ethylene oxide, propylene oxide, and/or butylene oxide and mixtures thereof.

For the alcohol ethoxylates, the alkyl chain of the aliphatic alcohols can be linear or branched, primary or secondary, and generally contains from about 8 to about 22 carbon atoms. The alkyl chain can be saturated or unsaturated. The alcohol ethoxylates can have a narrow (“narrow range ethoxylates”) or a broad (“broad range ethoxylates”) homolog distribution of the ethylene oxide. Examples of commercially available nonionic surfactants of this type are available under the tradenames Tergitol, Genapol, and Neodol. Preferably, the alcohol ethoxylates are mixed C9/11 or C11/15 alcohol ethoxylates, condensed with an average of from 6 to 15 moles, preferably from 6 to 12 moles, and most preferably from 6 to 9 moles of ethylene oxide per mole of alcohol. Preferably the ethoxylated nonionic surfactant so derived has a narrow ethoxylate distribution relative to the average.

The alkoxy block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):
HO-(EO)ₓ(PO)_{y}(EO)_{z}—H (A)
where
EO represents ethylene oxide,
PO represents propylene oxide,
y equals at least 15,
(EO)_{x+z} equals 20 to 80% of the total weight of said compounds, and, the total molecular weight is preferably in the range of about 2000 to 15,000.

Another group of nonionic surfactants appropriate for use in the new compositions can be represented by the formula (B):
R-(EO,PO)ₐ(EO,PO)_{b}—H (B)
wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:
RO—(BO)ₙ(EO)ₓ—H (C)
wherein
R is an alkyl group containing 1 to 20 carbon atoms,
n is about 5-15 and x is about 5-15.

Also useful as the nonionic block copolymer surfactants, which also include polymeric butoxy groups, are those which may be represented by the following formula (D):
HO-(EO)ₓ(BO)ₙ(EO)_{y}—H (D)
wherein
n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula: 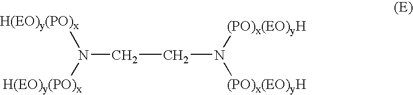
where
(EO) represents ethoxy,
(PO) represents propoxy,
the amount of (PO)ₓ is such as to provide a molecular weight prior to ethoxylation of about 300 to 7500, and the amount of (EO)_{y} is such as to provide about 20% to 90% of the total weight of said compound.

Of these, the nonionic surfactants represented by formula (A) above are preferred; specific examples of which include those materials presently commercially available under the tradename “Pluronic®” from BASF. Of those of formula (A), block copolymers having an average molecular weight between 7000 to 11,000 are preferred. Examples of such components include Pluronic 87, described as EO₆₁ PO_{41.5} EO₆₁, having an average molecular weight of about 7700 and Pluronic 88, described as EO₉₈ PO_{41.5} EO₉₈, having an average molecular weight of about 10800.

The anionic surfactants used in a) ii) can be those anionic surfactants typically used in toilet cleaning compositions. Examples include sulfonates, sulfates, carboxylates, phosphates, and mixtures of the above compounds. Suitable cations in this case are alkali metals such as, for example, sodium or potassium, or alkaline earth metals such as, for example, calcium or magnesium, and ammonium, substituted ammonium compounds, including mono-, di- or triethanolammonium cations and mixtures of the cations. The following types of anionic surfactants are of particular interest: alkyl ester sulfonates, alkylsulfates, alkyl ether sulfates, alkylaryl sulfates and sulfonates, and secondary alkanesulfonates, alkenyl sulfonates. Examples of suitable anionic surfactants include alpha olefin sulfonates, dodecylbenzene sulfonates, lauryl ether sulfates, lauryl monethanol amides. Those of ordinary skill in the art will appreciate that certain anionic surfactants may have to be avoided as some may be incompatible with some of the disinfecting and anti-lime scale agents mentioned herein. Those of ordinary skill in the art will appreciate that the compatibility of the anionic surfactant and the various disinfecting and anti-lime scale agents can be easily determined and thus incompatibility can be avoided in the situations.

Examples of materials which can be used as disinfectants in the solid block include the halohydantoins having a structure 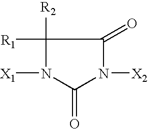
wherein X₁ and X₂ are independently hydrogen, chlorine or bromine and R₁ and R₂ are independently alkyl groups having from 1 to 6 carbon atoms.

Examples of halohydantoins include, for example, N,N′-dichloro-dimethyl-hydantoin, N-bromo-N-chloro-dimethyl-hydantoin, N,N′-dibromo-dimethyl-hydantoin, 1,4-dichloro, 5,5-dialkyl substituted hydantoin, wherein each alkyl group independently has 1 to 6 carbon atoms, N-monohalogenated hydantoins such as chlorodimethylhydantoin (MCDMH) and N-bromo-dimethylhydantoin (MBDMH); dihalogenated hydantoins such as dichlorodimethylhydantoin (DCDMH), dibromodimethylhydantoin (DBDMH), and 1-bromo-3-chloro-5,5,-dimethylhydantoin (BCDMH); and halogenated methylethylhydantoins such as chloromethylethylhydantion (MCMEH), dichloromethylethylhydantoin (DCMEH), bromomethylethylhydantoin (MBMEH), dibromomethylethylhydantoin (DBMEH), and bromochloromethylethylhydantoin (BCMEH), and mixtures thereof. These materials are more fully discussed in U.S. Pat. Nos. 4,560,766; 4,537,897; and 4,564,424.

Other disinfectants include sodium dichloroisocyanurate (DCCNa) and sodium dibromoisocyanurate.

Examples of anti-lime scale agents include organic acids (for example, citric acid, lactic acid, adipic acid, oxalic acid and the like), organic phosphoric salts, alkali metal polyphosphates, sulfonic, and sulphamic acids and their salts, bisulfate salts, EDTA, phosphonates, HEDP and the like.

Examples of essential oils include pine oil, Anetlhole 20/21 natural, Aniseed oil china star, Aniseed oil globe brand, Balsam (Perui), Basil oil (India), Black pepper oil, Black pepper oleoresin 40/20, Bois de Rose (Brazil) FOB, Bomneol Flakes (China), Camphor oil, White, Camphor powder synthetic technical, Canaga oil (Java), Cardamom oil, Cassia oil (China), Cedarwood oil (China) BP, Cinnamon bark oil, Cinnamon leaf oil, Citronella oil, Clove bud oil, Clove leaf, Coriander (Russia), Counmarin 69° C. (China), Cyclamen Aldehyde, Diphenyl oxide, Ethyl vanilin, Eucalyptol, Eucalyptus oil, Eucalyptus citriodora, Fennel oil, Geranium oil, Ginger oil, Ginger oleoresin (India), White grapefruit oil, Guaiacwood oil, Gurjun balsam, Heliotropin, Isobornyl acetate, Isolongifolene, Juniper berry oil, L-methyl acetate, Lavender oil, Lemon oil, Lemongrass oil, Lime oil distilled, Litsea Cubeba oil, Longifolene, Menthol crystals, Methyl cedryl ketone, Methyl chavicol, Methyl salicylate, Musk ambrefte, Musk ketone, Musk xylol, Nutmeg oil, Orange oil, Patchouli oil, Peppermint oil, Phenyl ethyl alcohol, Pimento berry oil, Pimento leaf oil, Rosalin, Sandalwood oil, Sandenol, Sage oil, Clary sage, Sassafras oil, Spearmint oil, Spike lavender, Tagetes, Tea tree oil, Vanilin, Vetyver oil (Java), and Wintergreen oil.

Examples of non-quaternary ammonium based germicidials include from pyrithiones, dimethyldimethylol hydantoin, methylchloroisothiazolinone/methylisothiazolinone sodium sulfite, sodium bisulfite, imidazolidinyl urea, diazolidinyl urea, benzyl alcohol, 2-bromo-2-nitropropane-1,3-diol, formalin (formaldehyde), iodopropenyl butylcarbamate, chloroacetamide, methanamine, methyldibromonitrile glutaronitrile, glutaraldehyde, 5-bromo-5-nitro-1,3-dioxane, phenethyl alcohol, o-phenylphenol/sodium o-phenylphenol, sodium hydroxymethylglycinate, polymethoxy bicyclic oxazolidine, dimethoxane, thimersal dichlorobenzyl alcohol, captan, chlorphenenesin, dichlorophene, chlorbutanol, glyceryl laurate, halogenated diphenyl ethers, phenolic compounds, mono- and poly-alkyl and aromatic halophenols, resorcinol and its derivatives, bisphenolic compounds, benzoic esters (parabens), halogenated carbanilides, 3-trifluoromethyl-4,4′-dichlorocarbanilide, and 3,3′,4-trichlorocarbanilide. More preferably, the non-cationic antimicrobial agent is a mono- and poly-alkyl and aromatic halophenol selected from the group p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol 2-diethylmethyl-3,5-dimethyl p-chlorophenol, 6-sec-octyl-3-methyl p-chlorophenol, p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3 -methylphenol, para-chloro-meta-xylenol, dichloro meta xylenol, chlorothymol, and 5-chloro-2-hydroxydiphenylmethane.

Examples of quaternary ammonium germicidals include Such useful quaternary compounds are available under the BARDAC®, BARQUAT®, HYAMINE®, LONZABAC®, BTC®, and ONYXIDE®) trademarks, which are more fully described in, for example, McCutcheon's Functional Materials (Vol. 2), North American Edition, 2001, and the respective product literature from the suppliers identified below. For example, BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active) (also available as 80% active (BARDAC® 208M)); described generally in McCutcheon's as a combination of alkyl dimethyl benzyl ammonium chloride and dialkyl dimethyl ammonium chloride); BARDAC® 2050 is described to be a combination of octyl decyl dimethyl ammonium chloride/didecyl dimethyl ammonium chloride, and dioctyl dimethyl ammonium chloride (50% active) (also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT®) MB-50, MX-50, OJ-50 (each 50% liquid) and MB-80 or MX-80 (each 80% liquid) are each described as an alkyl dimethyl benzyl ammonium chloride; BARDAC® 4250 and BARQUAT® 4250Z (each 50% active) or BARQUAT® 4280 and BARQUAT® 4280Z (each 80% active) are each described as alkyl dimethyl benzyl ammonium chloride/alkyl dimethyl ethyl benzyl ammonium chloride. Also, HYAMINE®) 1622, described as diisobutyl phenoxy ethoxy ethyl dimethyl benzyl ammonium chloride (available either as 100% actives or as a 50% actives solution); HYAMINE® 3500 (50% actives), described as alkyl dimethyl benzyl ammonium chloride (also available as 80% active (HYAMINE® 3500-80); and HYAMINE® 2389 described as being based on methyldodecylbenzyl ammonium chloride and/or methyldodecylxylene-bis-trimethyl ammonium chloride. (BARDAC®, BARQUAT® and HYAMINE® are presently commercially available from Lonza, Inc., Fairlawn, N.J.). BTC® 50 NF (or BTC® 65 NF) is described to be alkyl dimethyl benzyl ammonium chloride (50% active); BTC® 99 is described as didecyl dimethyl ammonium chloride (50% active); BTC® 776 is described to be myristalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC® 818-80%)); BTC® 824 and BTC® 835 are each described as being of alkyl dimethyl benzyl ammonium chloride (each 50% active); BTC® 885 is described as a combination of BTC® 835 and BTC® 818 (50% active) (available also as 80% active (BTC® 888)); BTC® 1010 is described as didecyl dimethyl ammonium chloride (50% active) (also available as 80% active (BTC® 1010-80)); BTC® 2125 (or BTC® 2125 M) is described as alkyl dimethyl benzyl ammonium chloride and alkyl dimethyl ethylbenzyl ammonium chloride (each 50% active) (also available as 80% active (BTC® 2125-80 or BTC® 2125 M)); BTC®) 2565 is described as alkyl dimethyl benzyl ammonium chlorides (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). (BTC® and ONYXIDE® are presently commercially available from Stepan Company, Northfield, Ill.).

Another component of the ITB system is the fragrance. The fragrance or perfume is preferably placed within a gel system which is then deposited in the second chamber of the housing. The gel system can be formed by a variety of components known to those of ordinary skill in the art. For example, it can be formed from absorbents, starch based systems, modified celluloses, natural gums and other materials which can form a gel when the perfume base, aforementioned gel components, and water or hydrophilic solvents are mixed together. An important issue is that in the present invention, the fragrance is not exposed to the path of or the flushing water side of the toilet so the present system provides excellent lasting fragrance and deodorant effect, and well-balanced aroma, and in particular with good durability of the fragrance during the later period of use. The gel system for the perfume is preferably that which is embodied within U.S. Pat. No. 5,780,527, the contents of which are hereby incorporated by reference.

The housing which comprises the first covered chamber and the second optionally covered chamber for the perfume, can be formed out of a variety of materials with plastics being preferred. Suitable plastics include polyethylene, polypropylene, and the like; the only criteria being that the selected plastic is not affected by the components of the block or perfume gel. The housing can be made by typical plastic forming processes.

The first covered chamber of the article has at least one inlet opening and at least one outlet opening. The inlet opening allows toilet water to enter the first covered chamber. Toilet water flowing from orifices under a toilet rim will flow into an opening, allowing contact of the toilet water with the composition placed in the first chamber. After contact, the water then flows out through at least one outlet opening of the first chamber and into the toilet bowl. The inlet opening(s) can be placed within the cover of the first chamber (for example, slits) and/or even on the top of the chamber (for example, a hole). The outlet opening(s) can be placed at the bottom of the chamber.

The second chamber, which contains the perfume, is open towards the toilet bowl and is away from the flushing water side of the toilet. With gelled perfumes, it is not a requirement that the second chamber have any covering so as to retain the perfume. However, it is possible that if liquid perfumes are used, then the second chamber can be optionally covered and have one or more openings which would permit the fragrance to emanate from the second chamber.

The housing can be attached to a hanger, for example, an unfoldable flexible suspension hook, for placing the article on the rim of a toilet bowl so that the first covered chamber is in the path of the flush water.

Examples of cleaning compositions which can be used with the present invention are shown in the table below.

| Component | Ex. 1 | Ex. 2 | Ex. 3 | Ex. 4 | Ex. 5 |
|---|---|---|---|---|---|
| Dodecyl Benzene Sulfonate Na¹ | 25 | 10 | 40 | 35 | 35 |
| Alfa Olefine Sulfonate Na² | 25 | 10 | 5 | 32 | 32 |
| Lauryl monoethanolamide³ | 10 | 8 | 5 | 2 | 5 |
| Sodium Lauryl Ether Sulfate⁴ | 10 | | | 4.5 | 5 |
| Pluronic 68⁵ | 10 | | | 3 | |
| Na Sulfate | 20 | | | 21.5 | 21 |
| Pluronic 87 or 88⁶ | | 70 | 50 | | |
| Alcohol ethoxylate C₉-C₁₁ 6EO⁷ | | 2 | | | |
| Silica | | | | 2 | 2 |

¹Dodecyl Benzene Sulfonate Sodium (80-90% active) - anionic
²Alpha Olefin Sulfonate Sodium - anionic
³Lauryl Monoethanolamide - non-ionic
⁴Sodium Lauryl Ether Sulfate (70% active) - anionic
⁵Polyoxyethylene (160) polyoxypropylene (30) glycol - non-ionic
⁶Pluronic 87 E₆₁ P_{41.5} E₆₁ - Molecular Weight 7700 - HLB 24 - non-ionic Pluronic 88 E₉₈ P_{41.5} E₉₈ - Molecular Weight 10800 - HLB 28 - non-ionic
⁷Alcohol ethoxylate C₉-C₁₁ 6EO - non-ionic

The above examples can be made either by melting the various components together and placing the melt into the first chamber of the housing or by placing the components into a suitable extruder and extruding out a block having a desired shape and size.

Examples of Disinfecting Compositions Include

A hydantoin tablet containing 94 wt. % Dantochlor powder (about 86% 1,3-dichloro-5,5-dimethylhydantoin) and 6.0 wt. % of an inert binder, comprising a 5 wt. % solution of laponite can be made by extrusion (with a die diameter and shape suited to the proposed first chamber) at a temperature of from about 80 to 90° F. and a pressure at the end of the extruder barrel ranging from about 50 to about 350 psi. An appropriate sized block can then be cut from the extrudate and allowed to cool to room temperature. Another example can use a 2 wt. % solution of laponite was used. Yet other examples can replace the 5 wt. % solution of laponite with sodium stearate and water (respectively representing 5 wt. % and 4 wt. % of composition prior to drying; respectively representing 10 wt. % and 6 wt. % of the final composition prior to drying; and respectively representing 6 wt. % and 7.5 wt. % of the composition, prior to drying). Yet other examples can use a binder that contain a 2 wt. % laponite solution and sodium stearate (the laponite solution representing 3 wt. % of the composition and the sodium stearate representing 7.5 wt. % of the composition, prior to drying; a 5 wt. % laponite solution and sodium stearate (respectively representing 3 wt. % and 7.5 wt. % of the composition, prior to drying).

An example of a bleach compositions suitable for use in the present invention include compositions having the general ranges as follows:

| Component | Range Percentage w/w |
|---|---|
| Alpha olefin sulfonate | 0-35 |
| Sodium lauryl ether sulfate | 3.0-6.0 |
| Bleaching agent (e.g., DCCNa or Hydantoin) | 0.5-25 |
| Lauryl monoethanolamide | 2.0-5.0 |
| Dodecyl benzene sulfonate Na | 50-70 |
| Na sulfate anhydrous | 15-25 |
| Silica | 1.0-2.0 |

An example of a anti lime scale agent composition is as follows:

| Description | Qty |
|---|---|
| Spary dried silica | 9.46 |
| Na sulfate | 10.81 |
| Na dodecylbenzenesulfonate (80%) | 74.05 |
| Na₄ HEDP | 1.62 |
| Alcohol C₁₃/C₁₅ | 1.08 |
| Dye | 2.97 |

Referring now to the figures, FIG. 1 shows a perspective view of article 1. Housing 9 has disposed on it connector 7, which connects hanger 3 to housing 9. Hole 5, shown here on the top of housing 9, permits water to flow into the first chamber described above. Cover 15 closes the first chamber. Second chamber 11 is shown on the opposite side from cover 15. Perfume gel 13 is placed within second chamber 11. Although shown as only taking up a portion of second chamber 11, perfume gel 13 can also take up the entire portion of second chamber 11.

FIG. 2 shows the rear view of article 1. The cleaning, disinfecting, water treating and/or anti-lime scale treating composition is placed behind cover 15, thus disposed within the first chamber. Openings 17 provide another way for toilet water to enter the first chamber as do openings 19. Those skilled in the art will recognize that depending on the type of toilet, openings 17 and 19 can be of different sized and positioned anywhere within cover 15. It will also be appreciated that in certain instances, there may not be a need for openings 17 and/or 19.

FIG. 3 shows a side view of article 1. In practice, hanger 3 (shown as a sprung suspension hook; those of ordinary skill in the art will appreciate that a hook already formed to fit over the rim of a toilet bowl could be provided in place of a sprung suspension hook) would be unfolded for suspending the article from the rim of a lavatory bowl (not shown) such that cover 15 faces towards the lavatory bowl wall and hole 5 is in the path of the lavatory flushing water as well as second chamber 11 facing into the lavatory bowl. For ease of manufacture, the hanger 3 can be formed as a separate component from the housing 9, and the housing 9 is formed with a connector 7 of appropriate cross-section into which the lower end of the hanger 3 is inserted during manufacture. The lower end of the hanger 3 can comprise a raised, chamfered portion such that, upon insertion, the hanger 3 remains engaged within the connector 7 by a snap-fitting arrangement.

FIG. 4 shows a bottom view of article 1. When water from the lavatory passes through hole 5 (as well as openings 17 and/or 19 is present/needed), a sufficient amount of water will interact with the cleaning, disinfecting, water treating, and/or anti-lime scale agent composition, dissolving a portion thereof. The flush water now containing an amount of the composition will flow through openings 21 and then into the lavatory bowl water.

FIG. 5 shows a front view of article 111. Housing 121 has disposed on it connector 123 (shown in FIG. 6), which connects hanger 123 to housing 121 in which disposed first chamber with cover 125 (see FIG. 6). Perfume gel 115 is placed within second chamber 117. Although shown as only taking up a portion of second chamber 117, perfume gel 115 can also take up the entire portion of second chamber 117. Hinge 119 connects the second chamber 117 to housing 121. Those of ordinary skill in the art will appreciate that second chamber 117 could be glued, welded, or otherwise connected to housing 121 instead of using hinge 119.

FIG. 6 shows the rear view of article 111. The cleaning, disinfecting, water treating and/or anti-lime scale treating composition 137 is placed behind cover 125, thus disposed within the first chamber. Openings 127, formed between slits 131, provide a way for toilet water to enter the first chamber. Those skilled in the art will recognize that depending on the type of toilet, openings 127 and slits 131 can be of different sized and positioned anywhere within cover 125. Lip 123 allows for a portion of toilet flush water to be directed into openings 123 so as to enter the first chamber.

FIG. 7 shows a side view of article 111 along line A-A of FIG. 5. In practice, hanger 113 (shown as a sprung suspension hook; those of ordinary skill in the art will appreciate that a hook already formed to fit over the rim of a toilet bowl could be provided in place of a sprung suspension hook) would be unfolded for suspending the article from the rim of a lavatory bowl (not shown) such that cover 125 faces towards the lavatory bowl wall and openings 127 and lip 133 are in the path of the lavatory flushing water as well as second chamber 117 facing into the lavatory bowl.

When water from the lavatory passes through openings 127, a sufficient amount of water will be channeled by lip 133 into openings 127, as well as water flowing directly into openings 127 without the need of lip 133, and will interact with the cleaning, disinfecting, water treating, and/or anti-lime scale agent composition 137, dissolving a portion thereof. The flush water now containing an amount of the composition 137 will flow through hole 129 and then into the lavatory bowl water.

While described in terms of the presently preferred embodiments, it is to be understood that the present disclosure is to be interpreted as by way of illustration, and not by way of limitation, and that various modifications and alterations apparent to one skilled in the art may be made without departing from the scope and spirit of the present invention.

1. A toilet bowl article which comprises:
a) a cleaning, disinfecting, water treatment, or anti-lime scale agent composition and mixtures thereof;
b) a perfume; and
c) a housing comprising (i) a first chamber having a cover for containing said composition, a first chamber having a cover and having at least one inlet opening and at least one outlet opening; (ii) a second, optionally covered chamber for containing said perfume; and (iii) a hanger for removably hanging the housing from the rim of a toilet, wherein when the article is suspended in the toilet bowl at least one inlet opening of the first covered chamber is in the path of flushing water and the second chamber is not in the path of flushing water.

2. The toilet bowl article of claim 1 wherein the perfume is a gelled perfume.

3. The toilet bowl article of claim 1 wherein the perfume is a liquid perfume.

4. The toilet bowl article of claim 3 wherein the second chamber is covered to enclose the perfume and the cover contains at least one opening to permit emanation of the perfume.

5. The toilet bowl article according to claim 1 wherein the composition is a cleaning composition.

6. The toilet bowl article according to claim 1 wherein the composition is a disinfecting composition.

7. The toilet bowl article according to claim 1 wherein the composition is an anti-lime scale agent composition.

8. The toilet bowl article according to claim 1 wherein the composition is a water treatment composition.

9. The toilet bowl article according to claim 1 wherein the at least one inlet opening is placed in the first chamber or the cover thereof.

10. The toilet bowl article of claim 9 wherein the at least one inlet opening is placed in the first chamber.

11. The toilet bowl article of claim 9 wherein the at least one inlet opening is placed in the cover of the first chamber.

12. The toilet bowl article of claim 9 wherein the at least one inlet opening is placed both in the first chamber and in the cover thereof.

13-37. (canceled)

38. A toilet bowl article of claim 1 comprising a composition which includes:
i) about 0 to about 100 wt % of one or more nonionic surfactants;
ii) about 100 to about 0 wt % of one or more anionic surfactants; and
iii) about 0 to 30 wt % of one or more processing aids, colorants, dyes, and the like.

39. The toilet bowl article of claim 38 comprising a composition which includes:
i) about 3 to about 55 wt % of one or more nonionic surfactants;
ii) about 75 to about 45 wt % of one or more anionic surfactants; and
iii) about 20 to 25 wt % of one or more processing aids, colorants, dyes, and the like.

40-41. (canceled)
